(19) United States
(12) Patent Application Publication
(10) Pub. No.: US 2008/0148554 A1
(43) Pub. Date: Jun. 26, 2008

(54) Batteries

(76) Inventors: Brien Merrill, New Fairfield, CT (US); Derek R. Bobowick, Sandy Hook, CT (US); Robert S. Ferrin, Bethel, CT (US)

Correspondence Address: FISH & RICHARDSON P.C., P.O. BOX 1022, MINNEAPOLIS, MN, 55440-1022, US

(21) Appl. No.: 11/642,430

(22) Filed: Dec. 20, 2006

(51) Int. Cl. H01M 6/00

(52) U.S. Cl. 29/623.1

(57) ABSTRACT

A method of making a battery includes forming a pressure relief vent, for example, a groove, in the housing of the battery after the anode and cathode are in the housing.

### TECHNICAL FIELD

This invention relates to batteries, and to related components and methods.

### BACKGROUND

Batteries or electrochemical cells are commonly used electrical energy sources. A battery contains a negative electrode, typically called the anode, and a positive electrode, typically called the cathode. The anode contains an active material that can be oxidized; the cathode contains or consumes an active material that can be reduced. The anode active material is capable of reducing the cathode active material. In order to prevent direct reaction of the active material of the anode and the active material of the cathode, the electrodes are electrically isolated from each other by a separator.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the battery during discharge.

Some types of batteries on occasion will generate gas, for example, hydrogen gas, during use.

### SUMMARY

The invention relates to batteries, and methods of making the batteries, that include a pressure relief vent in the housing that ruptures and releases gas generated during use of the battery when the pressure within the housing increases unacceptably due to a build-up of gas. The release of the gas can limit the potential harm to a user and to equipment that could result from a more general rupture of the battery.

In one aspect, the invention features a method of making a battery including a pressure relief vent, for example, by laser ablation, after an anode and a cathode have been provided in the housing. In some embodiments, the pressure relief vent is a groove. The housing can be, for example, a cylindrical body of the type commonly used in AA, AAA, AAAA, C, and D-size batteries, and the groove can be formed in the exterior surface of the end of the housing including the positive terminal. Alternatively, the pressure relief vent can be formed in the side-wall of the housing or the end of the housing including the negative terminal.

In another aspect, the invention features a method of making a battery including only a single pressure relief vent by forming the pressure relief vent, for example, using laser oblation, in the housing before or after the anode and cathode are provided in the housing.

In another aspect, the invention features a battery including an anode and a cathode within a housing. The housing includes a single pressure relief vent having an area of reduced thickness. For example, the area of reduced thickness can be a groove that has a thickness of greater than 50% of the thickness of the housing adjoining the groove. In some embodiments, a battery that includes the pressure relief vent can, as a result, include a relatively thin insulating seal in the end including the plastic terminal (for example, as an alternative to a vent plug or a spring pressure relief plug). The seal can be relatively thin because the seal may not include and/or be associated with venting components. A battery including a relatively thin seal can have additional room for other battery components (e.g., electrode active materials). This can result in an increase in the amount of electrode active materials in a battery can result in enhanced electrochemical performance by the battery.

A battery including an ablated region can be relatively easily manufactured. The geometry of an ablated region can be relatively easily designed to suit a particular battery (e.g., a cylindrical cell, a prismatic cell) and/or selected burst pressure threshold. For example, a large electrochemical cell (e.g., a D battery) can include one or more relatively large ablated regions in its housing, and a small electrochemical cell (e.g., a AAA battery) can include one or more relatively small ablated region in its housing. As another example, in certain embodiments, one or more of the characteristics of an ablated region (e.g., thickness, area, geometry) can be designed to suit a particular battery (e.g., a cylindrical cell, a prismatic cell) and/or selected burst pressure threshold. In some embodiments, existing battery parts can be relatively easily adapted to include one or more ablated regions. As an example, in certain embodiments, the positive terminal, negative terminal, and/or battery housing wall of a battery can be modified to include ablated regions.

Other aspects, features, and advantages of the invention are in the drawings, description, and claims.

### DESCRIPTION OF DRAWINGS

FIG. 1A is a cross-sectional view of an embodiment of a battery.

FIG. 1B is a perspective view of the housing of the battery of FIG. 1A.

FIG. 1C is a sectional view of the housing of FIGS. 1A and 1B.

FIG. 2 is a perspective view of a housing of a battery.

FIG. 3 is a perspective view of a housing of a battery.

### DETAILED DESCRIPTION

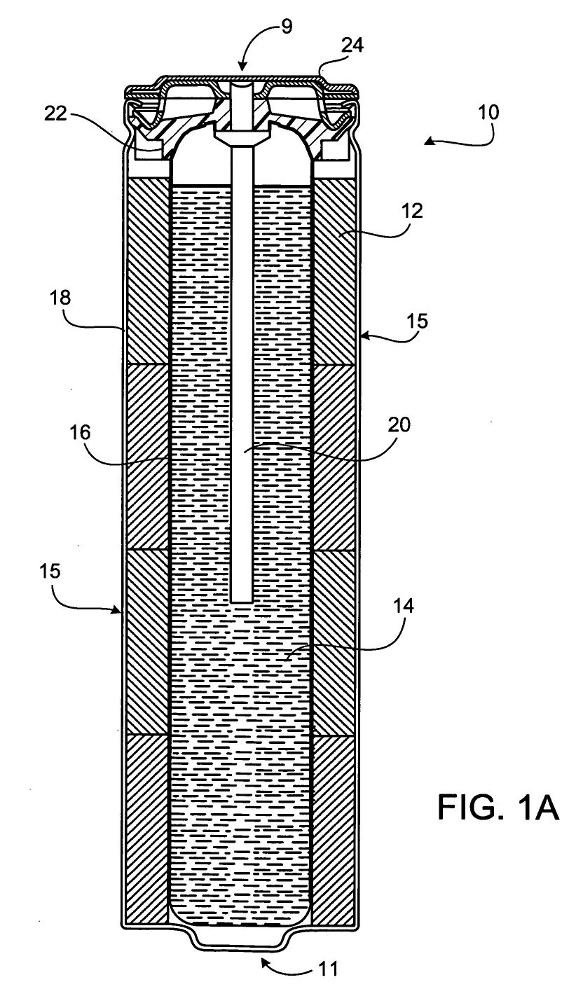

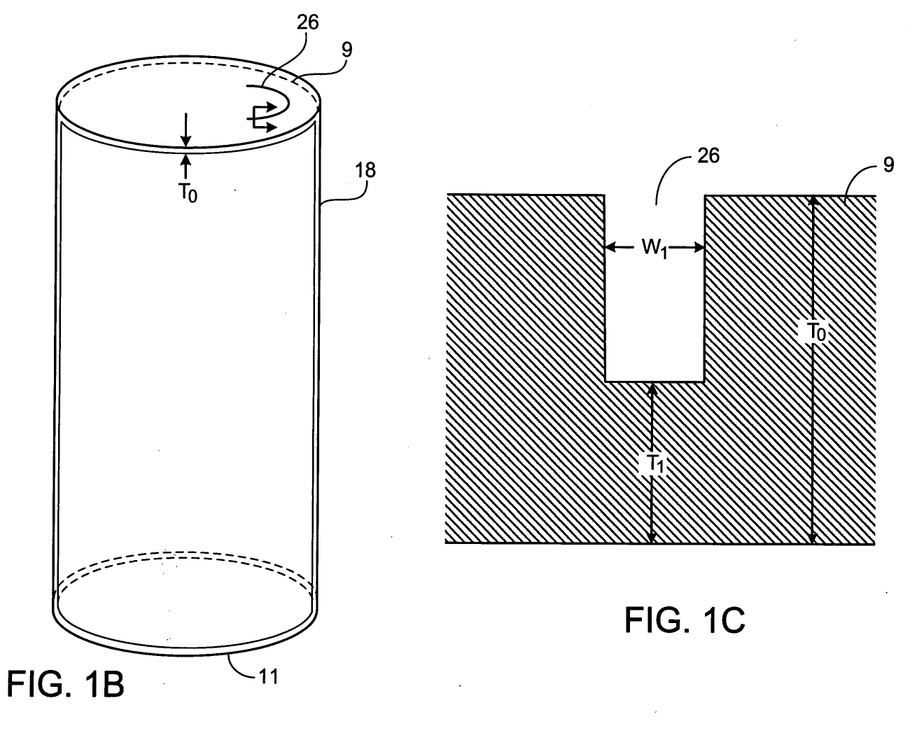

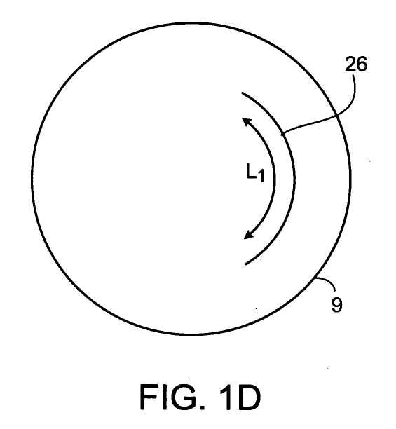

Referring to FIG. 1A, a battery 10 has a housing 18 containing a cathode 12, an anode 14, a separator 16 between cathode 12 and anode 14, and a current collector 20. Cathode 12, which is in contact with housing 18, includes a cathode active material, and anode 14 includes an anode active material. An electrolyte also is dispersed throughout battery 10. Housing 18 includes a cylindrical portion 15, a negative terminal 9, and a positive terminal 11. Negative terminal 9 includes a seal 22, a metal top cap 24, and a current collector 20. Positive terminal 11 is at the end of battery 10 opposite from negative terminal 9.

Referring to FIG. 1B, the negative terminal 9 of housing 18 has a thickness T₀. The thickness T₀ can be, for example, at least 10 mm (e.g., at least 20 mm or at least 25 mm) and/or up to 30 mm (e.g., up to 35 mm or 40 mm). Negative terminal 9 includes a pressure relief vent in the form of a laser ablated groove 26. Groove 26 is in the shape of an arc.

Housing 18 can be formed of one or more different materials. For example, housing 18 can be made of one or more metals or metal alloys, such as nickel, nickel-plated steel (e.g., nickel-plated cold-rolled steel), stainless steel, aluminum-clad stainless steel, aluminum, or an aluminum alloy, or can be made of a plastic, such as polyvinyl chloride, polypropylene, a polysulfone, acrylonitrile butadiene styrene (ABS), or polyamides.

Referring to FIG. 1C, groove 26 has a width W₁ and the portion of negative terminal 9 defining the floor of groove 26 has a thickness T₁. Width W₁ can be, for example, up to 7 mm (e.g., up to 40 mm) and/or at least 0.5 mm (e.g., at least 2 mm). Thickness T₁ can be, for example, up to 0.30 mm (e.g., up to 0.25 mm, up to 0.20 mm, or up to 0.18 mm), and/or at least 0.02 mm (e.g., at least 0.05 mm or at least 0.10 mm). Thickness T₁ is less than 100% the thickness T₀ of housing 18 and can be, for example, less than 60%, less than about 50%, or less than about 40%, and/or greater than 15% the thickness T₀ of housing 18, (e.g., greater than about 25% or greater than about 35%).

Groove 26 has the same width at the top of the groove as at the bottom. In other embodiments the width of the groove can vary. For example, the walls defining groove 26 can taper inward from the opening of the groove to the floor of the groove and thus have a greater width at the opening than at the floor.

Referring to FIG. 1D, groove 26 is a semi-circular arc that is concentrically located with respect to the circumference of negative top 9 Groove 26 has a length L₁ that can be, for example, up to 35 mm, (e.g., up to 25 mm or up to 15 mm), and/or at least 1 mm, (e.g., at least 4 mm or at least 10 mm).

Groove 26 is formed on the exterior surface of negative terminal 9 after assembly of the cell components such as cathode 12, anode 14, separator 16, and current collector 20 by laser irradiation. For example, the groove can be formed using a SL1308(T)Q continuous wave YAG laser having a scanning head (beam expander×4, 160 mm flat field) that has a Q-switch frequency of 5 KH_{z} and an average power output of 8 watts.

The laser can be pass over the area, for example, at 50 mm/sec for the number of passes required (e.g., 2 passes-25 passes, 5 passes-20 passes, or 15 passes) to provide a groove having a depth of between 0.05 mm and 0.25 mm (e.g., 0.1 mm-0.2 mm or 0.15 mm).

Groove 26 forms an aperture (e.g., by rupturing) at battery internal pressures of greater than, for example, 25 psi, (e.g., greater than 50 psi, greater than 250 psi, greater than 500 psi, or greater than 1000 psi).

Housing 18 optionally can include an inner metal wall and an outer electrically non-conductive material such as heat-shrinkable plastic. Optionally, a layer of conductive material can be disposed between the inner wall and cathode 12. The layer may be disposed along the inner surface of the inner wall, along the circumference of cathode 12, or both. This conductive layer can be formed, for example, of a carbonaceous material (e.g., graphite). Such materials include, for example, LB1000 (Timcal), Eccocoat 257 (W.R. Grace & Co.), Electrodag 109 (Acheson Colloids Co.), Electrodag 112 (Acheson), Varniphite 5000 (Nippon), and EB0005 (Acheson). Methods of applying the conductive layer are disclosed, for example, in Canadian Patent No. 1,263,697.

Cathode 12 includes a cathode active material and can also include a binder. The electrolyte is dispersed throughout cathode 12. The weight percentages provided herein with respect to components of cathode 12 are determined after the electrolyte has been dispersed through cathode 12.

The cathode active material can be, for example, a manganese oxide, such as manganese dioxide (MnO₂). The manganese dioxide can be electrolytically-synthesized MnO₂ (EMD), chemically-synthesized MnO₂ (CMD), or a blend of EMD and CMD. Distributors of manganese dioxides include Kerr-McGee Corp. (manufacturer of, e.g., Trona D and high-power EMD), Tosoh Corp., Delta Manganese, Delta EMD Ltd., Mitsui Chemicals, ERACHEM, and JMC. In certain embodiments, cathode 12 can include from 80% to 88% by weight (e.g., from 82% to 86% by weight) manganese dioxide (e.g., EMD). Other examples of cathode active materials include copper oxides, nickel oxyhydroxide, and pentavalent bismuth-containing metal oxides.

The conductive aid increases the electronic conductivity of cathode 12. An example of a conductive aid is carbon particles. The carbon particles can be any of the conventional carbon particles used in cathodes. The carbon particles can be, for example, graphite particles or carbon fibers.

Graphite particles that are used in cathode 12 can be any of the graphite particles used in cathodes. The particles can be synthetic, non-synthetic, or a blend of synthetic and non-synthetic, and they can be expanded or non-expanded. In certain embodiments, the graphite particles are non-synthetic, non-expanded graphite particles. Graphite particles can be obtained from, for example, Brazilian Nacional de Grafite (Itapecirica, MG Brazil (MP-0702X)) or Chuetsu Graphite Works, Ltd. (Chuetsu grades WH-20A and WH-20AF) of Japan. Cathode 12 may include for example, from 3% to 9% (e.g., from 4% to 7%) carbon particles by weight.

Carbon fibers are described in, for example, Luo et al., U.S. Pat. No. 6,858,349, and in Anglin, U.S. Patent Application Publication No. U.S. 2002/0172867 A1, published on Nov. 21, 2002, and entitled “Battery Cathode”. In some embodiments, cathode 12 can include less than two % by weight (e.g., less than 1% by weight and/or more than 0.1% by weight (e.g., more than 0.3% by weight) carbon fibers.

Cathode 12 can include, for example, from about 1% by weight to about 10% by weight of the conductive aid.

Examples of binders include polyethylene powders, polyacrylamides, Portland cement and fluorocarbon resins, such as polyvinylidenefluoride (PVDF) and polytetrafluoroethylene (PTFE). An example of a polyethylene binder is sold under the trade name Coathylene HA-1681 (available from Hoechst). Cathode 12 may include, for example, up to 2% binder by weight (e.g., up to 1% binder by weight). In certain embodiments, cathode 12 can include from 0.1% to two % (e.g., from 0.1% to 1%) binder by weight.

Cathode 12 can include other additives. Additives are disclosed, for example, in Mieczkowska et al., U.S. Pat. No. 5,342,712.

Cathodes (and cathode active materials) are described, for example, in Durkot et al., U.S. Patent Application Publication No. U.S. 2004/0237293 A1, published on Dec. 2, 2004, and entitled “Alkaline Cell With Flat Housing and Nickel Oxyhydroxide Cathode”; Durkot et al., U.S. Patent Application Publication No. U.S. 2004/0197656 A1, published on Oct. 7, 2004, and entitled “Alkaline Battery Including Nickel Oxyhydroxide Cathode and Zinc Anode”; Bowden et al., U.S. Patent Application Publication No. U.S. 2004/0076881 A1, published on Apr. 22, 2004, and entitled “Method of Making a Battery”; Eylem et al., U.S. Patent Application Publication No. U.S. 2005/0136328 A1, published on Jun. 23, 2005, and entitled “Battery Cathode”; Christian et al., U.S. Pat. No. 6,991,875, issued Jan. 31, 2006; Christian et al., U.S. Pat. No. 7,081,319, issued Jul. 25, 2006; Eylem et al., U.S. Patent Application Publication No. U.S. 2005/0058903 A1, published on Mar. 17, 2005, and entitled “Primary Alkaline Battery Containing Bismuth Metal Oxide”; Wang et al., U.S. Pat. No. Application Publication No. U.S. 2005/0058902 A1, published on Mar. 17, 2005, and entitled “Primary Alkaline Battery Containing Bismuth Metal Oxide”; and Kelsey et al., U.S. Pat. No. 6,207,322.

The electrolyte that is dispersed through cathode 12 (and/or the electrolyte used in the rest of battery 10) can be any of the electrolytes used in batteries. In some embodiments, cathode 12 can include from 5% to 8% (e.g., from 6% to 7%) electrolyte by weight. The electrolyte can be aqueous or non-aqueous. An aqueous electrolyte can be an alkaline solution, such as an aqueous hydroxide solution (e.g., LiOH, NaOH, KOH), or a mixture of hydroxide solutions (e.g., NaOH/KOH). For example, the aqueous hydroxide solution can include from 33% by weight to 40% by weight of the hydroxide material, such as 9N KOH (37% by weight KOH). In some embodiments, the electrolyte can also include up to 4% by weight (e.g., 2% by weight) of zinc oxide.

The electrolyte also can include other additives. As an example, the electrolyte can include a soluble material (e.g., an aluminum material) that reduces (e.g., suppresses) the solubility of the cathode active material in the electrolyte. In certain embodiments, the electrolyte can include one or more of the following: aluminum hydroxide, aluminum oxide, alkali metal aluminates, aluminum metal, alkali metal halides, alkali metal carbonates, or mixtures thereof. Electrolyte additives are described, for example, in Eylem et al., U.S. Pat. No. 7,049,030, issued May 23, 2006.

Anode 14 can be formed of any of the zinc materials used in battery anodes. For example, anode 14 can be a zinc gel that includes zinc metal particles, a gelling agent, and minor amounts of additives, such as gassing inhibitor. In addition, a portion of the electrolyte is dispersed throughout the anode.

The zinc particles can be any of the zinc particles (e.g., zinc fines) used in gel anodes. Examples of zinc particles include those described in Durkot et al., U.S. Pat. No. 6,284,410, and in Durkot et al., U.S. Pat. No. 6,521,378. In certain embodiments, anode 14 can include spherical zinc particles. Spherical zinc particles are described, for example, in Costanzo et al., U.S. Patent Application Publication No. U.S. 2004/0258995 A1, published on Dec. 23, 2004, and entitled “Anode for Battery”. The zinc particles can be a zinc alloy (e.g., containing a few hundred parts per million of indium and bismuth). Anode 14 may include, for example, from 40% to 90% (e.g., from 67% to 80%) zinc particles by weight.

Examples of gelling agents include polyacrylic acids, grafted starch materials, salts of polyacrylic acids, polyacrylates, carboxymethylcellulose or combinations thereof. Examples of polyacrylic acids include Carbopol 940 and 934 (available from Noveon Inc.) and Polygel 4P (available from 3V). An example of a grafted starch material is Waterlock A221 (available from Grain Processing Corporation, Muscatine, Iowa). An example of a salt of a polyacrylic acid is Alcosorb G1 (available from Ciba Specialties). Anode 14 may include, for example, from 0.1% to one % gelling agent by weight.

Gassing inhibitors can be inorganic materials, such as bismuth, tin, lead and indium. Alternatively, gassing inhibitors can be organic compounds, such as phosphate esters, ionic surfactants or nonionic surfactants. Examples of ionic surfactants are disclosed, for example, in Chalilpoyil et al., U.S. Pat. No. 4,777,100.

Separator 16 can be formed of any of the standard separator materials used in electrochemical cells (e.g., alkaline cells). For example, separator 16 can be formed of polypropylene (e.g., non-woven polypropylene or microporous polypropylene), polyethylene, polytetrafluoroethylene, a polyamide (e.g., a nylon), a polysulfone, a polyvinyl chloride, or combinations thereof. In some embodiments, separator 16 can include a layer of cellophane combined with a layer of a non-woven material. The non-woven material can include, for example, polyvinyl alcohol and/or rayon.

Seal 22 can be made of, for example, a polymer (e.g., nylon).

Cap 24 can be made of, for example, a metal or a metal alloy, such as aluminum, nickel, titanium, or steel.

Battery 10 can be a primary electrochemical cell or a secondary electrochemical cell. Primary cells are meant to be discharged (e.g., to exhaustion) only once, and then discarded. Primary cells are not intended to be recharged. Primary cells are described, for example, in David Linden, Handbook of Batteries (McGraw-Hill, 2d ed. 1995). Secondary electrochemical cells can be recharged for many times (e.g., more than fifty times, more than a hundred times, or more). In some embodiments, secondary cells can include relatively robust separators, such as separators that have many layers and/or separators that are relatively thick. Secondary cells can also be designed to accommodate for changes, such as swelling, that can occur in the cells. Secondary cells are described, for example, in Falk & Salkind, “Alkaline Storage Batteries”, John Wiley & Sons, Inc. 1969, and in Virloy et al., U.S. Pat. No. 345,124.

Battery 10 can be of any of a number of different voltages (e.g., 1.5 V, 3.0 V, 4.0 V), and/or can be, for example, a AA, AAA, AAAA, C, or D battery. While battery 10 is cylindrical, in some embodiments, a battery can be non-cylindrical. For example, a battery can be a coin cell, a button cell, a wafer cell, or a racetrack-shaped cell. In some embodiments, a battery can be prismatic. In certain embodiments, a battery can have a rigid laminar cell configuration or a flexible pouch, envelope or bag cell configuration. In some embodiments, a battery can have a spirally wound configuration, or a flat plate configuration. Batteries are described, for example, in Bedder et al., U.S. Pat. No. 4,622,277; McVeigh, Jr. et al., U.S. Pat. No. 4,707,421; Batson et al., U.S. Pat. No. 6,001,504; Berkowitz et al., U.S. patent application Ser. No. 10/675,512, filed on Sep. 30, 2003, and entitled “Batteries”; Totir et al., U.S. patent application Ser. No. 10/800,905, filed on Mar. 15, 2004, and entitled “Non-Aqueous Electrochemical Cells”; Durkot et al., U.S. Patent Application Publication No. U.S. 2004/0237293 A1, published on Dec. 2, 2004, and entitled “Alkaline Cell With Flat Housing and Nickel Oxyhydroxide Cathode”; and Berkowitz et al., U.S. Patent Application Publication No. U.S. 2005/0112467 A1, published on May 26, 2005, and entitled “Battery Including Aluminum Component”.

A cell (e.g., a cylindrical cell) can be prepared by, for example, rolling an anode, separator, and cathode together, and placing them in a housing. The housing (containing the anode, the cathode, and the separator) can then be filled with the electrolytic solution and subsequently hermetically sealed with, for example, a cap and annular insulating gasket.

In some embodiments, a cell (e.g., a cylindrical cell) can be prepared by spirally winding an anode, a cathode, and a separator together, with a portion of the cathode current collector extending axially from one end of the roll.

Methods for assembling electrochemical cells are described, for example, in Moses, U.S. Pat. No. 4,279,972; Moses et al., U.S. Pat. No. 4,401,735; and Kearney et al., U.S. Pat. No. 4,526,846.

Housing 18 optionally can include an inner metal wall and an outer electrically non-conductive material such as heat-shrinkable plastic.

All references, such as patent applications, publications, and patents, referred to herein are incorporated by reference in their entirety.

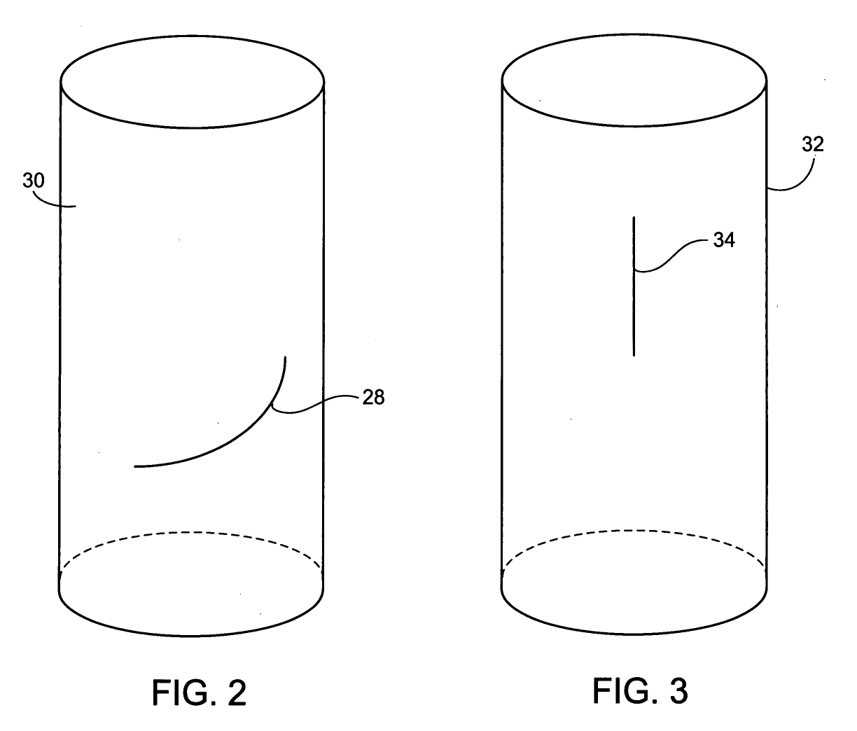

Other embodiments are in the claims. For example, referring to FIG. 2, a housing 30 includes a pressure relief vent in the form of laser ablated groove 28 on the side wall. Similarly, referring to FIG. 3, a housing 32 includes a pressure relief vent in the form of a laser ablated straight groove 34 on the sidewall. The pressure relief vent alternatively can also be located on the positive terminal. The pressure relief vent also can be formed by laser ablation of an interior surface of the housing. Moreover, instead of having one general thickness a laser ablated groove can have a plurality of thicknesses along its length.

The laser ablated groove also can be formed, for example, on a sidewall after partial assembly of the battery, or at least after placement of the cathode and anode in the housing.

What is claimed is:

1. A method of making a battery, comprising
providing a housing including an anode and a cathode within the housing, and
forming a pressure relief vent in the housing, including the anode and the cathode within the housing, using a laser.

2. The method of claim 1, wherein the housing is cylindrical body having a negative terminal at a first end and a positive terminal at a second end of the housing and the pressure relief vent is formed in the first end of the housing.

3. The method of claim 2, wherein the pressure relief vent comprises a groove in the housing.

4. The method of claim 3, wherein a portion of the housing defines the floor of the groove and has a thickness of between 0.04 mm and 0.30 mm.

5. The method of claim 4, wherein the portion a thickness of between 0.1 mm and 0.20 mm.

6. The method of claim 3, wherein the groove has a maximum diameter of between 0.5 mm and 10 mm.

7. The method of claim 3, wherein the groove has a length of between 1 mm and 30 mm.

8. The method of claim 1, wherein the pressure relief vent comprises a groove in the housing.

9. The method of claim 8, wherein a portion of the housing defines the floor of the groove and has a thickness of between 0.04 mm and 0.30 mm.

10. The method of claim 9, wherein the portion has a thickness of between 0.1 mm and 0.2 mm.

11. The method of claim 8, wherein the groove has a maximum diameter of between 0.5 mm and 10 mm.

12. The method of claim 8, wherein the groove has a length of between 1 mm and 30 mm.

13. The method of claim 8, wherein the groove extends at least 50% through the housing.

14. The method of claim 1, wherein the housing has an interior and an exterior and the pressure relief vent is formed in the exterior surface.

15. The method of claim 1, wherein at least two pressure relief vents are formed in the housing.

16. The method of claim 1, wherein only a single pressure relief vent is formed in the housing.

17. The method of claim 1, wherein the cathode comprises manganese dioxide and the anode comprises zinc.

18. A method of making a battery comprising
forming a single pressure relief vent in a housing, and
inserting an anode and a cathode into the housing.

19. A battery comprising an anode and a cathode within a housing, the housing including only one pressure relief vent comprising an area of reduced thickness.

20. The battery of claim 19, wherein the area of reduced thickness has a thickness of less than 50% of the adjoining housing.

21. The battery of claim 19, wherein the single pressure relief vent is a groove.
